(19) United States
(12) Patent Application Publication
(10) Pub. No.: US 2001/0039510 A1
(43) Pub. Date: Nov. 8, 2001

(54) Advertisement testing method and system

(76) Inventor: David E. Galomb, Allentown, PA (US)

Correspondence Address: DAVID E. GALOMB, 523 N. 22ND STREET, ALLENTOWN, PA, 18104, US

(21) Appl. No.: 09/681,608

(22) Filed: May 8, 2001

Related U.S. Application Data
(60) Provisional application No. 60/202,841, filed on May 8, 2000.
(60) Provisional application No. 60/203,828, filed on May 12, 2000.
(60) Provisional application No. 60/210,017, filed on Jun. 8, 2000.
(60) Provisional application No. 60/222,603, filed on Aug. 2, 2000.
(60) Provisional application No. 60/241,608, filed on Oct. 20, 2000.

(51) Int. Cl. G06F 17/60

(52) U.S. Cl. 705/14

(57) ABSTRACT

A method and system for testing advertisements, including at least one Internet website and an offline marketing method and means of directing consumers to the website.

### CROSS REFERENCE TO REFERENCE TO RELATED APPLICATIONS

This application claims the benefit of and priority to the following previously filed provisional applications: Ser. No. 60/202,841 filed on May 8, 2000, Ser. No. 60/203,828 filed on May 12, 2000, Ser. No. 60/210,017 filed on Jun. 8, 2000, Ser. No. 60/222,603 filed on Aug. 2, 2000, and Ser. No. 60/241,608 filed on Oct. 20, 2000.

### BACKGROUND OF INVENTION

The invention relates to methods and systems for testing advertisements on the Internet. There are now numerous firms that provide advertising (i.e. ad) management services for others on the Internet, and among these management services are various ways to test and optimize the effectiveness of the advertisements. Often firms will use conventional as well as proprietary techniques to accomplish these goals. Although it is probably fair to say that no two ad management firms use exactly the same methods of ad testing and optimization, the majority do however have some commonalties. Most operate as a sort of middleman between the advertiser and the owner of a property (e.g. website, newsletter, e-mail, etc.) who has advertising space available. The ad management firm uses their own expertise and technology in an effort to best match their inventory of advertising with their inventory of advertising space. While some of these firms are becoming adept at placing advertisements on properties where they are most likely to be effective in generating a consumer response, there does exist some significant drawbacks to both the advertiser and the property owner when employing this so called middleman method of ad management, as it relates to testing and optimization. In particular, one of the biggest problems advertisers face is the lack of an instant means to optimize the effectiveness of their advertisements. In a typical situation, an advertiser will work with the ad management firm and preliminarily attempt to identify the desired target audience, and how that target audience can best be reached. Once identified, the ad management firm then uses their expertise and technology to determine which properties the advertisements should be placed on that will most likely reach the intended audience. After placing the ads, consumer response often needs to be evaluated over a period of time, and the ads continually updated in order to determine what has produced the most effective results. The problem is that this method is very inefficient. It takes a lot of time and effort for both the advertiser and the ad management firm, and does not provide an objective and reliable way to compare the effectiveness of an original ad with the updated ad. This is true even if the updated ad is placed in the exact same position on the exact same property as the first ad, because the people viewing the updated ad will most often be different than those who viewed the original one, albeit having the same characteristics (i.e. target profile). Even if the updated ad were to reach the exact same individuals, and be positioned in the exact same location of the exact same property, it would still not be the best of comparisons, because the surrounding content of that property will likely be different, the mood of the individual will likely be different, and the circumstance that drew them to the property the second time will likely be different. Further compounding the problem is the great reliance the advertiser places on the ad management firms'expertise and technology to identify and reach the desired target audience. An advertiser can never be entirely sure if an unsuccessful advertisement campaign was due to the advertisement itself, the property it was placed on, or the expertise of the ad management firm in selecting its placement. The need is clear for a better method and system that allows advertisers to directly, instantly, and more objectively evaluate the effectiveness of their advertisements on the Internet. There have been some attempts to address this problem by making do-it-yourself ad serving software available to advertisers. These software tools allow advertisers to directly control the dissemination of their own advertisements and make updates to them as often as desired. Although this do-it-yourself solution does put the control of the ad serving directly in the hands of the advertiser, it still does not provide them with an objective and reliable method and system to evaluate and test their advertisements, and avoid the impact of the constantly changing circumstances of their destination properties. The need is also clear for a structured platform and medium where advertisers can directly, instantly, and more objectively evaluate and update their advertisements. There is also some do-it-yourself ad management software that is available for website owners and it allows them to directly manage the advertising space they have available on their own website. Although this type of do-it-yourself ad management software may conceivably be adapted to carry out the technical functions of placing advertisements on a website, the purpose of the software is to simply put the website owner in control of the ad placement process, rather than the ad management firm. The software in itself does not provide advertisers with a method and system for testing and optimizing their advertisements that is any more direct or objective than the aforementioned methods. As such, the need clearly remains for an advertisement testing method and system that allows advertisers to directly control the placement and optimization of their advertisements. Some ad management firms have also attempted to serve advertisers better by providing them with a means to quickly evaluate multiple versions of an advertisement by disseminating them simultaneously, and then choosing the one that works the best. Although this may be effective in providing the advertiser with faster information it is still subject to the same drawbacks, and potential unreliability as those previously discussed. It is also clear that in addition to the need for advertisers to directly and instantly control the testing and optimizing of their advertisements, there is also a need for an advertisement testing method and system that provides reliable information. The present invention resolves all of these shortcomings and drawbacks, as well as provides other advantages that will become apparent by reading the preferred embodiment.

### SUMMARY OF INVENTION

The invention is an advertisement testing method and system that provides a direct, objective, instant, and reliable means for advertisers to test and optimize their advertisements on the Internet. In the preferred embodiment, the invention includes at least one Internet media website that is primarily devoted to the simultaneous display of competing advertisements. Advertisers may lease, purchase, compete for, or otherwise acquire rights to advertising space and time on the website, and use the said space and time to test and optimize consumer response to their advertisements in comparison to competing ads. Software tools, services, and products are also provided to assist advertisers in their testing and evaluations. In one preferred embodiment, the invention includes a network of Internet websites, each devoted to a specific advertising topic. In another preferred embodiment, the invention includes an offline marketing method and means to drive targeted consumer traffic to the advertisements.

### DETAILED DESCRIPTION

What is disclosed is an advertisement testing method and system that provides a platform and medium structured for advertisers to directly, objectively, instantly, and reliably test, evaluate, and optimize the effectiveness of their advertisements in comparison to competing advertisements. The term advertisement, also occasionally referred to herein as ad, is used in a broad sense, and is intended to mean the calling of attention to ones offerings. Advertisements may include, without limitation, static and animated graphical images, banner ads, button ads, streaming media, television broadcasts, commercials, webcasting, audio, text, interactive media, and hyperlinks. The term offerings is also used in a broad sense and includes, without limitation, goods and services. In the preferred embodiment, the platform and medium includes at least one Internet website that is directed to a target audience, typically consumers, and primarily dedicated to the simultaneous presentation of competing advertisements from multiple advertisers. The said website may have multiple pages to accommodate as many advertisements as necessary.

In one preferred embodiment, advertising lots of predefined sizes and shapes and in predetermined positions on each website page are first created. Advertisers then purchase, rent, compete for, or otherwise acquire the right to insert their advertising into each lot for a predetermined period of time. In one arrangement of this preferred embodiment, the advertising lots may be positioned adjacent to each other in rows and columns covering the majority of the viewing area of each web page. Advertisers may insert their advertisements into an acquired lot, and then update the ad with newer versions, or alternately rotate it with other ads to evaluate what effect it has on consumer response. If desired, advertisers may also be permitted to acquire multiple ad lots, which allows them to display two or more ads simultaneously and evaluate what effect that has on consumer response. Advertisers may also be offered the option acquiring rights to an ad lot only when a consumer who fits a desired profile is viewing the website. It shall be appreciated that consumer response may be measured in any number of ways including, but not limited to activating the ad to engage in further activity or interaction with the advertising source, rating the ad, saving or book marking the ad, clicking on a hyperlink embedded in the ad, purchasing goods or services from the advertising source, or any other desired measurement means. In another arrangement of this preferred embodiment, the created advertising lots may be larger in the beginning web pages and then become increasingly smaller for later web pages. For example, web page one, which, if desired, may also serve as what is commonly known as the homepage and the primary entry point to the website, may be divided into ten predefined advertising lots. Pages two through four of the website may each be divided into twenty predefined advertising lots. Pages five through nine may each be divided into forty advertising lots, and so on. This arrangement allows advertisers to evaluate what effect repositioning their ad to a larger or smaller lot, and on a different page, has on consumer response.

In another preferred embodiment of the invention, ad lots in varying in shapes and sizes are created and presented on the same web page. Advertisers may purchase, lease, compete for, or otherwise acquire the advertising space, (i.e. ad lots) in predefined units equating to any desired area of measurement. This allows advertisers to choose their own advertising lot size and shape and evaluate consumer response to their advertising when presented simultaneously with competing ads that are larger, smaller and of an alternate shape. Alternately, advertisers may be invited to choose from a selection of varying ad lot shapes and sizes that are already predefined.

In another preferred embodiment of the invention, advertising slots of predefined time periods are first created. Advertisers may then purchase, rent, compete for, or otherwise acquire the right to present their advertising during that predefined period of time when the ad slot becomes activated. In one arrangement of this preferred embodiment the said ad slots may be made available to advertisers in combination with the ad lots of the previously mentioned preferred embodiments. A consumer who activates an ad lot, typically by clicking on it with a computer mouse, will be presented with additional advertising from the advertiser of that lot. In this way, advertisers may first test various creatives within the ad lot to determine what is the most effective at causing consumers to activate it, and then second, upon activation of the ad lot, present and test other advertisements during the allotted time of the ad slot to determine what is the most effective at causing consumers to perform another desired action, such as purchase a product or service, sign up for a mailing list, enter a contest, hyperlink to the advertisers website, or any other desired response.

In another preferred embodiment of the invention, a predetermined number of ad lots may be created on each page of the website and positioned on top of each other in a single column format, allowing consumers to scroll up and down the column to find a desired ad. The remaining portion of the web page primarily serves as a viewing area for the corresponding ad slots, which are presented to the consumer upon activation of an ad lot.

In another preferred embodiment of the invention, advertisement enhancement services and enabling features are made available with each advertising lot. The said services and features may include, without limitation, e-commerce enabling that allows advertisers to complete financial transactions with consumers directly from the ad lot, a standardized consumer feedback form, language translation, voice command activation, live customer assistance, credit card and password verification. If desired, the said services and features may be presented in the form of a consumer control panel that is positioned in a predetermined location on each web page, or alternately may be displayed and activated by the consumer when desired. Typically, when an advertiser acquires the right to an advertising lot, and if applicable, to a corresponding advertising slot, they are offered the opportunity to purchase, or otherwise utilize the above mentioned enhancement services and enabling features within that lot and during that slot. The services and features requested by the advertiser become active on the consumer control panel when the control panel is in association with the that particular ad lot and ad slot. Consumers may associate the control panel with any desired advertisement lot by simply clicking on the advertisement inserted into it. The consumer control panel provides consumers with a uniform method of interacting with multiple advertisers, and allows advertisers to more objectively compare the effect of such features when employed in their advertising.

In another preferred embodiment of the invention, advertisers may be provided with additional services and information to assist them in evaluating the effectiveness of their advertisements, such as but not limited to statistical reporting, consumer profiling, advertisement analysis, and competitor analysis. If desired, the information and services that are provided may be specific to a particular lot. One example of information that may be provided to an advertiser is a real time reporting of the percentage of consumers currently viewing the web page, who have responded to their ad lot. This allows an advertiser to instantly evaluate what effect the ad currently displayed in their lot is having on the total consumer audience.

In another preferred embodiment of the invention, advertising lots may be arranged under predetermined topics. In one arrangement of this embodiment, a website may have multiple pages with each page devoted to a specific topic. For example, one page may be entitled Sports, and display only advertisements that in some way relates to sports. Another page may be entitled Entertainment, and display only advertisements that relate to entertainment. Consumers may be provided with a predetermined list of all advertisement topics to select from, or alternately may be provided with a means to choose their own topic and display whatever advertisements have the most relevance to it.

In another preferred embodiment of the invention, the platform and medium includes a network of websites. Whereas, each website is in the network is primarily dedicated to the simultaneous display of competing advertisements that relate to only one topic. For example, one website in the network may be exclusively dedicated to displaying advertisements that in some way relates to the topic of games. If desired, each website in the network may provide hyperlinks to the other websites in the network.

In another preferred embodiment of the invention, an offline marketing method and means is used to drive targeted consumer traffic to the advertisements by publishing a collection of Universal Resource Locators, commonly known as URLs or domain names, in print media, such as, but not limited to, newspapers, magazines, and direct mailings. Each URL, when entered into an Internet search engine or browser, directs the consumer to advertisements that relate to a specific advertising topic. The particular advertising topic represented by each URL may be indicated in its alphanumeric designation. For example, the URL www.go2-movies.com may direct a consumer to a website or website page that is primarily dedicated to the simultaneous display of competing advertisements that relate to movies. If desired, and as illustrated in the above URL example, all URLs in the collection may begin with the same alphanumeric prefix. It shall be appreciated that the alphanumeric prefix provided in the above URL is merely exemplary and is by no means a limitation.

The various preferred embodiments of the present invention result in an advertisement testing method and system that enables advertisers to directly, objectively, instantly, and reliably test and optimize their advertisements on the Internet, and includes a platform and medium for employing the same. The invention may be employed in a very straightforward manner by simply providing predetermined advertising lots for competing advertisements, or alternately may employed in a very complex arrangement, where ad lots are associated with ad slots, and both ad lots and ad slots may be integrated with advertising enhancement services and features, as well being used in combination with an offline marketing method that includes a collection of URLs to drive targeted consumer traffic to the advertisements.

I claim:

1. A method for advertisement testing comprising:
providing of at least one Internet website
dividing of the website space into predefined advertising lots
conveying the advertising rights within each lot to a different advertiser
simultaneous displaying of competing advertisements on the website.

2. The method of claim 1 wherein predefined advertising time is provided with each predefined advertising lot.

3. The method of claim 1 wherein a network of Internet websites are provided.

4. The method of claim 1 wherein advertisement enhancement features and services are provided for each advertisement lot.

5. The method of claim 1 wherein the advertising is arranged under predetermined topics.

6. The method of claim 1 wherein an offline marketing method and means is used to direct targeted consumer traffic to the advertisements.

7. The method of claim 1 wherein real time statistical information is provided to advertisers.

8. An advertisement testing system comprising:
a means for displaying advertisements on the Internet
a means for dividing advertising space into predefined advertising lots
a means to convey the advertising rights for each predefined advertising lot
a means to simultaneously display advertisements in each predefined advertising lot.

9. The system of claim 8 wherein a means provides advertising time in association with each predefined advertising lot.

10. The system of claim 8 wherein the means for displaying the advertisements on the Internet is a network of websites.

11. The system of claim 8 wherein a means for advertisement enhancement features and services are provided for each advertisement lot.

12. The system of claim 8 wherein a means for arranging the predefined advertising lots under predefined advertising topics is provided.

13. The system of claim 8 wherein a means for driving targeted consumer traffic to the advertisements is provided.

14. The system of claim 8 wherein a means for real time statistical information is provided to advertisers.

15. An offline marketing method for directing targeted consumer traffic to an advertisement testing method and system on the Internet, comprising:
obtaining a collection of URLs
arranging the URLs under predetermined advertising topics
publishing the URLs in print media
directing the URLs to advertising on the Internet.

16. The method of claim 15 wherein each URL indicates the advertising topic it is directed to in its alphanumeric designation.

17. The method of claim 15 wherein all URLs in the collection begin with the same alphanumeric prefix.
